(19) United States
(12) Patent Application Publication
(10) Pub. No.: US 2010/0224807 A1
(43) Pub. Date: Sep. 9, 2010

(54) MULTIPLE FLOW-RATE DISPENSING VALVE AND METHOD

(76) Inventor: Robert C. Brizes, Painesville, OH (US)

Correspondence Address: RANKIN, HILL & CLARK LLP, 38210 GLENN AVENUE, WILLOUGHBY, OH, 44094-7808, US

(21) Appl. No.: 12/398,641

(22) Filed: Mar. 5, 2009

(51) Int. Cl. F16K 31/122

(52) U.S. Cl. 251/63.6; 251/324; 222/1

(57) ABSTRACT

The present invention overcomes deficiencies in the art. A valve device is provided that includes a valve body defining a chamber for receiving fluid to be dispensed from the valve device, a seal contact surface located on the valve body, near a location where fluid discharges from the chamber, one or more grooves within the seal contact surface, and a reciprocatable piston rod supporting a seal that selectively contacts the seal contact surface, the piston rod being received at least partially within the chamber. The groove and seal have structural configurations that prevent the seal from fully blocking the groove when the piston rod is in a first position where the seal contacts a portion of the seal contact surface including the groove, and as a result fluid within the chamber may enter the groove when the piston rod is in this first position. A method of dispensing fluid in variable amounts is also provide that includes the steps of providing a valve device as described above, repeatedly moving the piston from the first position to the second position, thus allowing fluid within the chamber to enter the groove and then be swept out of the valve device in a dropwise manner.

### BACKGROUND OF THE INVENTION

Blending of fluids is important in many different industries. Blending can be done either in an approximated manner or in an extremely precise manner depending upon the use of the final product. For example, blending in a precise manner is often performed when different colors of base fluids, having otherwise similar physical properties, are mixed. If the goal is to produce a final mixture having a desired color, then precise measuring of the base fluids is critical.

When precise blending is performed, the blending process is often gravimetric. A receiving container is placed upon a precise measuring scale. Base fluids from multiple sources are added individually to the container through a metering pump and valve system. Each source may have its own dedicated metering system or a single metering system being fed from multiple fluid sources may by used.

Valves used in the metering systems often operate in a pressure release manner. Such a valve includes a piston and piston rod holding a seal, wherein the seal stops flow when the valve is in a closed position. The piston and the rod are biased to the closed position by spring force. By applying pressure into the valve via compressed air or another fluid, in a space on the opposite side of the piston from the spring(s), the rod seal is lifted out of a bore, and thus, opens the valve to a certain degree, dependent on the amount of air pressure applied.

When a selected amount of fluid of a particular type is to be added in the receiving container, pressure is first applied at a high level in order to open the valve wide, and move most of the required fluid into the receiving container quickly. As the desired amount of fluid is approached, pressure is reduced so that the flow rate of added fluid is also reduced. However, even at this lower rate, it is difficult to add very small amounts of fluid. A drawback of the art, at present, is that the precision of the gravimetric scale is greater than the precision of available valve systems. An improved distribution valve is desired.

One technique that has been tried with existing valves is to repeatedly pulse the valve with air pressure, so as to open and close the valve quickly. Unfortunately, this does not produce drops reliably in common valves. What is further desired is a new method of using an improved valve which can deliver fluid repeatedly and reliably in a precise dropwise manner.

### BRIEF SUMMARY OF THE INVENTION

The present invention overcomes deficiencies in the art. A valve device is provided that includes a valve body defining a chamber for receiving fluid to be dispensed from the valve device, a seal contact surface located on the valve body, near a location where fluid discharges from the chamber, one or more grooves formed in the seal contact surface, and a reciprocatable piston rod supporting a seal that slidingly contacts the seal contact surface, the piston rod being received at least partially within the chamber.

The groove(s) and seal have structural configurations that prevent the seal from fully blocking the groove when the piston rod is in a first position where the seal contacts a portion of the seal contact surface including the groove, and as a result fluid within the chamber may enter the groove when the piston rod is in this first position. The piston rod and seal can also be moved to a second position on the seal contact surface that is downstream of the groove. Fluid flow out of the chamber is fully prevented when the piston rod and seal are in the second position.

A method of dispensing fluid in variable amounts is also provided that includes the steps of providing a valve device as described above, repeatedly moving the piston from the first position to the second position, thus allowing fluid within the chamber to repeatedly enter and pass through the groove and valve device in a dropwise manner.

The method further includes the step of moving the piston rod to a third position, upstream of the groove, where the seal is spaced apart from the seal contact surface, thus allowing fluid to exit the valve in a stream.

These and other features, aspects and advantages of the present invention will be fully described by the following description, appended claims, and accompanying drawings.

### BRIEF DESCRIPTION OF THE DRAWINGS

In the following figures, some of the same or similar types of elements or corresponding parts are provided with the same reference numbers in order to prevent the item from needing to be reintroduced.

FIG. 1 is a schematic representation of a system and method for distributing fluids;

FIG. 2 is an exploded view of a first embodiment of the valve device of the present invention;

FIG. 3A is a cross sectional view of the first embodiment of the valve device with the piston rod in a first position;

FIG. 3B is a detailed view of a portion of FIG. 3A;

FIG. 4A is a cross sectional view of the first embodiment of the valve device with the piston rod in a second position;

FIG. 4B is a detailed view of a portion of FIG. 4A;

FIG. 5A is a cross sectional view of the first embodiment of the valve device with the piston rod in a third position;

FIG. 5B is a detailed view of a portion of FIG. 5A;

FIG. 6 is a cross sectional view of a variation of the first embodiment of the valve device;

FIG. 7 is a cross sectional view of another variation of the first embodiment of the valve device;

FIG. 8 is an exploded view of a second embodiment of the valve device of the present invention;

FIG. 9 is a cross sectional view of the second embodiment of the valve device with a piston rod in a first position;

FIG. 10 is a cross sectional view of the second embodiment of the valve device with the piston rod in a third position; and

FIG. 11A is a cross sectional view of an insert component in the second embodiment of the invention; and

FIG. 12 is a top view and detailed portion of the insert component.

### DETAILED DESCRIPTION OF THE INVENTION

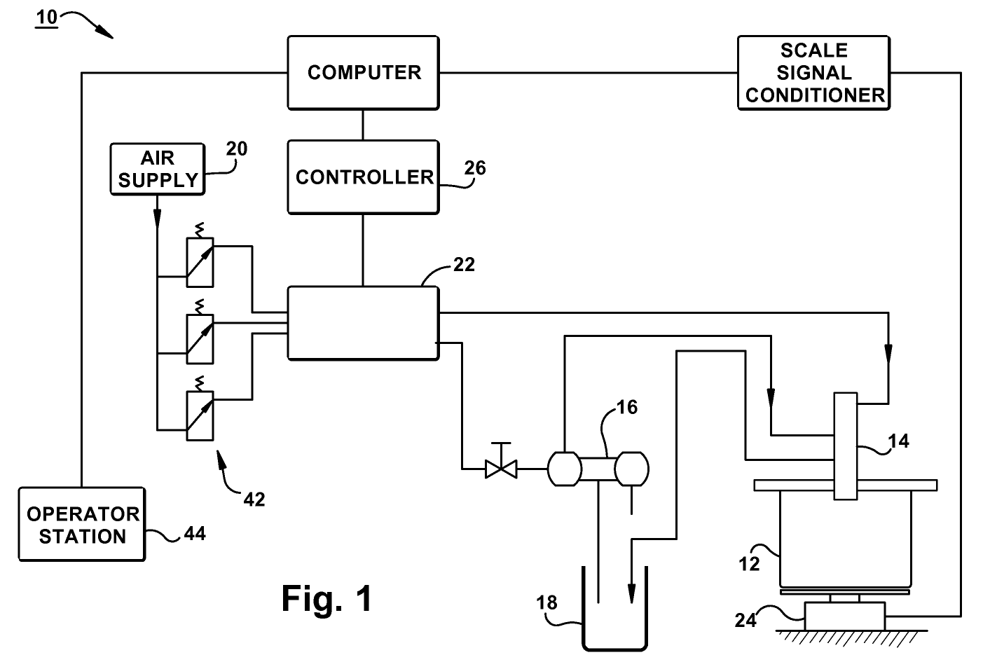

An improved system and method for distributing fluids is provided. Referring to FIG. 1, the system 10 shown schematically, in general, includes a receiving container 12 for mixed fluids, one or more improved dispensing valve devices 14, described in more detail below, pumps 16, containers holding base supply fluids 18, compressed air supplies 20 and associated solenoids 22 for the valves and pumps, a scale 24, and computer-based controls 26 that receive input from an operator and control the system 10 accordingly.

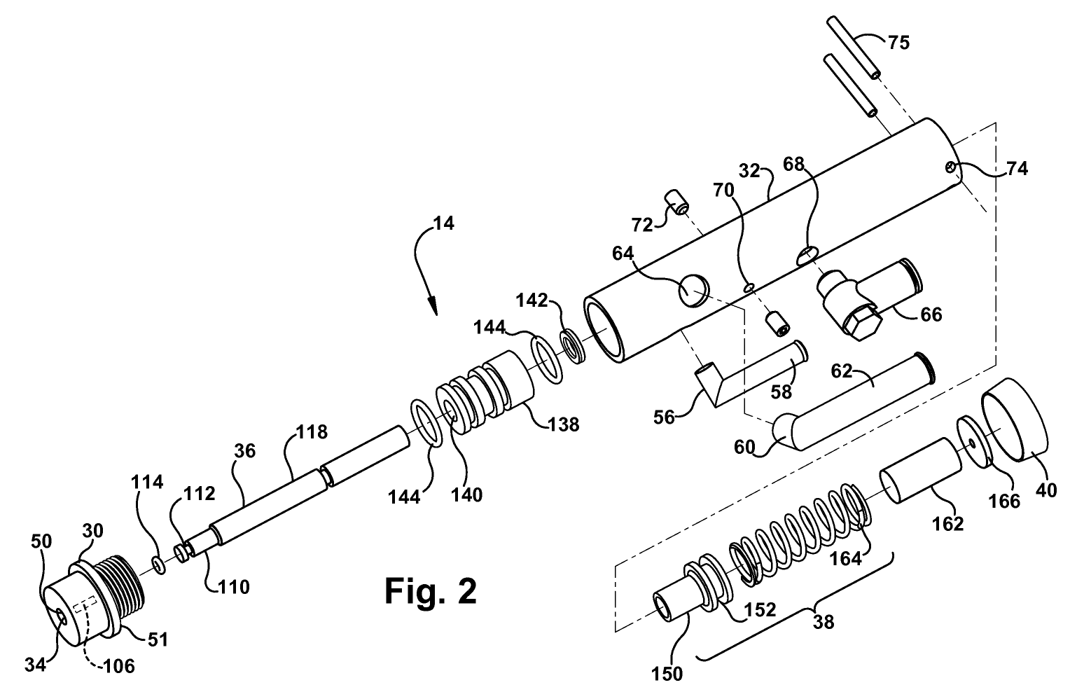

Improved distribution is facilitated by a first embodiment of the improved dispensing valve device 14 shown in FIG. 2, and described in more detail below. The valve device 14 includes, amongst other components, a distal end cap 30, a main body 32, a seal contact surface 34, a piston rod 36 supporting an O-ring seal 114, a spring and piston system 38, and a proximal end cap 40. The term “downstream” is used herein and refers to moving away from the portion of the main body that holds the liquid being dispensed.

The system 10 for distributing fluids is shown in FIG. 1. A scale 24 is situated on a stationary surface, for example, the floor in a factory. A receiving container 12 is placed on top of the scale 24 such that the weight of base fluids added to the receiving container 12 may be measured. One or more improved dispensing valve devices 14 of the present invention are situated above the receiving container 12. In order to avoid the repeated cleaning of a commonly used valve, one valve device 14 for each base fluid is used herein. The dispensing valve devices 14 preferably are configured in a circular pattern (not shown), although any configuration of dispensing valve devices 14 is possible. Each dispensing valve device 14 includes a supply port for base fluid and preferably a return port for base fluid, as described below. Each dispensing valve device 14 also includes a supply port for pressurized air. Base fluid is supplied to each dispensing valve device 14 from a corresponding supply container 18. For example, when colored inks are blended, a supply of base liquid ink of a particular color, for instance red, is taken from a supply container 18 by a dedicated pump 16 and pumped to a dedicated dispensing valve device 14 above the receiving container 12. The ink can be returned to the supply container 18 from the valve device continuously in order to prevent ink from drying in and clogging transfer lines and the dispensing valve device 14.

The source of compressed air 20 supplies the pumps 16 and also the dispensing valve devices 14. Through a solenoid 22, the compressed air is provided periodically, as required. The air is supplied at different pressures, as required, via a series of regulators 42 or a single, adjustable regulator.

Computer-based controls 26 manage/change the timing and pressure of air supplied to the dispensing valve devices 14 and the pumps 16. The computer controls 26 receive input from an operator and also status information, most particularly the weight measured by the scale 24. The computer controls 26 also receive information regarding the amount of fluids in the supply containers 18 for inventory purposes. The computer controls 26 are programmed with various color mixing recipes within their memory, and with preset routines for distributing compressed air pressure to the pumps 16 and valve devices 14 in order to complete the preparation of such a recipe. The computer controls 26 use input from an operator to specify exact formulas, fluid amounts to be dispensed, and certain operating details. This input may be done at an operator's station 44 or at a remote computer connected to the computer controls 26.

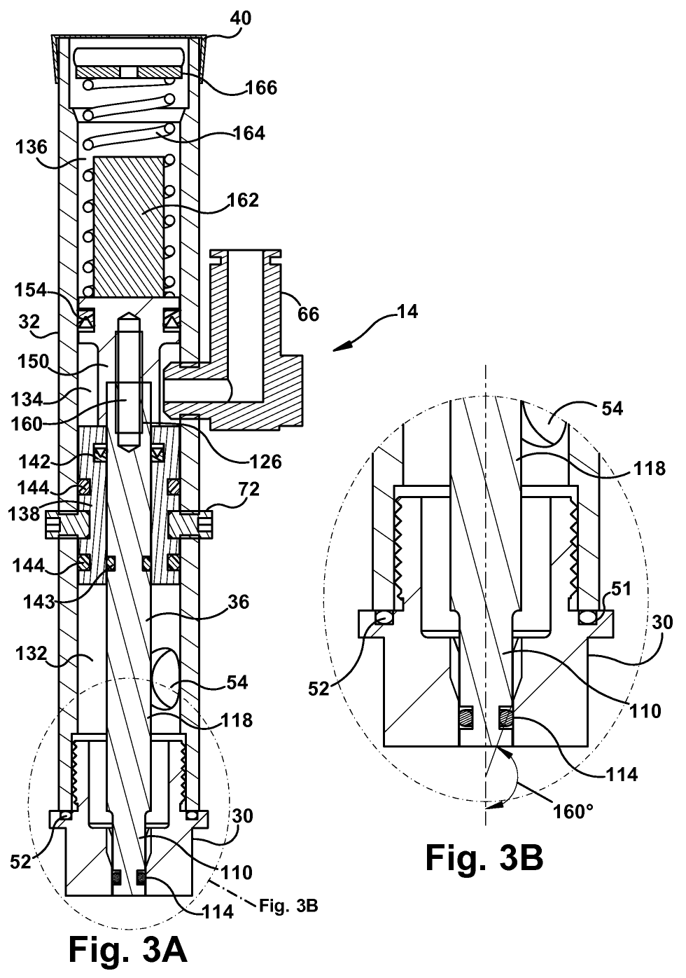

The valve device 14 shown in FIGS. 2, 3A and 3B includes a main body 32 that has an end cap 30 threadingly attached to it at a distal end. The distal end cap 30 is cylindrical with a central axial bore 50 therein. A gasket 52 is placed between the distal end cap 30 and the main body 32 to prevent leakage of fluids out of the bottom of the main body 32. The distal end cap 30 includes an annular seat 51 to receive the gasket 52.

The main body 32 is generally cylindrical and hollow. The main body 32 preferably includes at least three fluid ports therein with associated fittings attached to the exterior of the main body 32 at each port. A fluid supply port 54 is located approximately one quarter of the way along the length of the main body 32, closer to the distal end. Two pipe sections 56 and 58 are provided, connected together in an L-shape with the shorter of the two pipe sections (not shown in FIG. 3A) connected to the supply port 54. A supply of base fluid is provided through these pipe sections and into the main body 32 through the supply port 54. Two additional pipe sections 60 and 62 are provided, connected together in an L-shape with the shorter of the two pipe sections 60 connected to a return port 64, located about one third of the way along the length of the main body 32, closer to the distal end. Base fluid may be returned through these pipes back to a supply container 18. An air fitting 66 is attached to the third port 68, located approximately halfway along the length of the main body 32, and compressed air is introduced into the main body 32 through this fitting 66 and port 68 to move the piston rod 36 in the main body 32. Axially, the third port 68 is located between the supply and return ports 54 and 64. Two threaded lateral apertures 70 are located approximately halfway along the length of the main body 32 and extend into its open center. Screws 72 are secured in these apertures 70 and hold a divider 138, described below. Four lateral apertures 74 in combination with pins 75 are used to facilitate holding the proximal washer 166 in place.

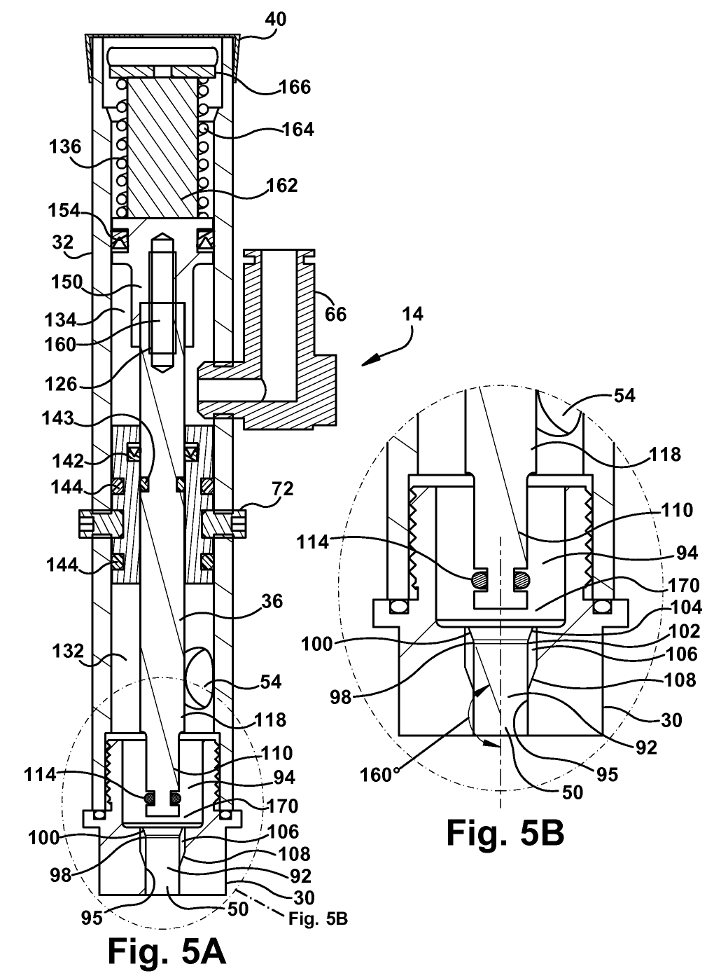

Referring to FIGS. 5A and 5B, returning to the distal end cap 30 and the longitudinal bore 50 provided therein, beginning at the distal end and extending toward the proximal end, the bore 50 includes at least two distinct sections 92 and 94 with different diameters. The inner surface 95 of the end cap 30, defining the first bore section 92 is a contact surface for the seal 114 supported on the piston rod 36. The first section 92 also has the smallest diameter in the bore 50. Two countersunk transition sections 98 and 100 are located between the first and second bore sections 92 and 94. The first transition section 98 has a sidewall 102 with an angle with respect to a longitudinal axis of about 160 degrees. The second transition section 100 is adjacent to the second bore section 94. The sidewall 104 of the second transition 100 is at an angle of approximately 140 degrees with respect to the longitudinal axis of the valve device 14.

Two longitudinal grooves 106 extend from the first bore section 92 to the second bore section 94. These grooves 106 are generally rectangular and have a sloped distal end 108 that extends from the base of the groove 106 to the wall surface of the first bore section 92. The sloped distal end 108 is at an angle of between 140-160 degrees to the longitudinal axis of the valve device 14. This helps prevent damage to the O-ring seal 114 on the piston rod 36 when it moves across the grooves 106. The distal end of each groove 106 ends about midway along the length of the first bore section 92. The depth of each groove 106 is approximately 0.03 inches and has a width of approximately 0.04 inches. The grooves 106 are narrow enough to prevent the O-ring seal 114 on the piston rod 36 from fully expanding into and blocking the groove 106. Thus, if the size of groove 106 is modified, the flexible O-ring seal 114 size is changed accordingly or vise-versa, such that this feature persists. Preferably, the grooves 106 are linear and oriented in a direction parallel to the movement of the piston rod 36.

Below the grooves 106 (downstream when considering the direction of fluid movement on discharge from the valve) is simply a smooth portion of a contact surface against which the O-ring seal 114 is compressed when moved by the piston rod past the grooves. When in this position, the O-ring forms a complete seal, so no fluid can pass by.

The width, depth and number of grooves 106 in the seal contact surface 95 of the end cap 30 determine how much fluid can pass through the valve device 14 when the seal 114 on the piston rod 36 is aligned with the grooves 106. Edges of the grooves 106 that are on the seal contact surface 95 and that periodically contact the O-ring seal 114 are rounded so that the O-ring seal 114 is not damaged when it moves across the grooves 106. The second section 94 of the longitudinal bore 50 has a greater diameter than the first section 92, and the diameter is generally constant.

Referring to FIGS. 2 and 3A, the piston rod 36 is elongate and is more narrow at its distal end. The piston rod's distal end fits into the end cap 30, as described in more detail below. A first piston portion 110 begins at the distal end and has a constant diameter, except for an annular groove 112 that is within the outer surface of the first piston portion 110 adjacent the distal end. The O-ring seal 114 is seated in this annular groove 112. A second portion 118 is adjacent to and has a greater diameter than the first portion 110 and has an annular seat the supports an O-ring 143. An axial bore 126 is placed in the proximal end of the piston rod 36 and this bore 126 is threaded.

Referring to FIGS. 2 and 3A, a spring and piston system 38, including a divider 138, is used to create three separate chambers 132, 134 and 136 within the main body 32 and used to provide desired motion of the components held therein. The cylindrical divider 138 is placed midway along the length of the main body's interior. This divider 138 is held in place with screws 72 placed through apertures 70 within the side wall of the main body 32. The divider 138 is cylindrical with an axial bore 140 extending along its entire length. The divider 138 includes a O-ring seal or cup seal 142 contacting the piston rod 36 that passes through the divider's bore 140 and two O-ring seals 144 on the exterior of the divider 138 contacting the inner wall of the main body 32. This divider 138 segregates the main body 32 into a first lower chamber 132 for receiving the base fluid and an upper space, part of which receives compressed air.

A piston/seal 150 is located in the upper space of the main body 34 and is slidable axially therein. The piston/seal 150 includes an annular groove 152 into which a U-cup ring 154 of rubber or another slidable material fits. The ring 154 allows easy sliding movement of the piston/seal 150 in the main body 32. The piston/seal 150 divides the upper space into the second and third chambers 134 and 136.

A cylindrical motion stop 162 is unsecured. The piston/seal 150 uses a screw 160 that secures the piston/seal 150 to the piston rod 36. The cylindrical motion stop 162 is located within the third chamber 136 between the piston/seal 150 and the proximal end cap 40 and positions a spring 164 therein. A washer 166 is placed between the spring 164 and the proximal end cap 40. This spring 164 biases the piston/seal 150 downwards. The motion stop 162 stops upward motion of the piston/seal 150 when the stop 162 contacts the washer 166.

The improved valve device of the present invention can be used in a similar manner to valves in the prior art in a system previously described in the Background section, with different amounts of air pressure applied thereto to open the valve device 14 different amounts.

Referring to FIGS. 2, 3A and 3B, base fluids are circulated through the valve device 14, entering at the supply port 54 and exiting at the return port 64. Compressed air, or another fluid, is supplied at the air fitting 66 at the other supply port 68 of the main body 34. Compressed air enters into the second chamber 134 and pushes the movable piston/seal 150 upwards, also lifting the piston rod 36 to allow fluid to exit the valve device 14.

Air fitting 66 is supplied with air from a three port, two position valve, thus movement into a second position releases air pressure within the valve device 14 while in a first position compressed air can be added to the valve device 14.

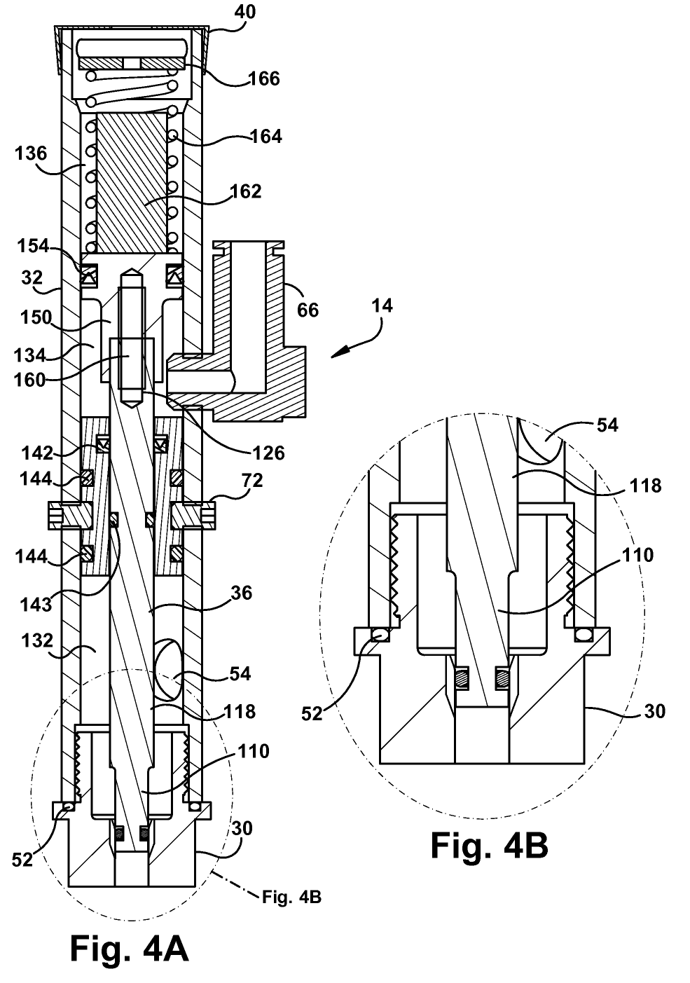

The valve device 14 is shown in FIG. 3A with the piston rod 36 in a closed position. At this time, preferably no fluid is being circulated in the lower chamber 132 of the main body 34, and the air pressure in the second chamber 134 of the main body is low, thus the piston rod 36 is kept in a lowest position by spring force. Referring to FIGS. 5A and 5B, when it is desirable to add base fluid to the receiving container placed below the valve device 14, air pressure is applied to the second chamber 134 of the main body 32. The piston/seal 150 moves, against spring force, upwards along with the piston rod 36 into a higher position, thus opening a space 170 between the piston rod 36 and seal contact surface 34. The pump for base fluid being actuated, base fluid flows through this space 170 and into the receiving container (not shown) in a stream. Typically, a pressure of approximately 90 psi is applied to open the piston rod 36 to this position. Approximately, 90%-98% of the required fluid is distributed from the valve device 14 with the piston rod 36 in this position. When approximately 98% of the desired amount of added base fluid is met, the air pressure provided is reduced, thus closing the valve device 14 via spring force of the spring 164. The air pressure to the valve is then repeatedly pulsed causing the piston rod to move from the position shown in FIG. 3A to the intermediate position shown in FIG. 4A. Depending on the viscosity of the fluid being distributed from the valve device the pumps are either constantly actuated, or not actuated when the piston rod is in the intermediate position, as more viscous fluid requires more pressure to enter the grooves and exit the valve device. Here, fluid can only enter/flow through the grooves 106 within the end cap 30. Preferably, each pulse of the piston rod 36 allows one drop of fluid to pass into the receiving container. Air pressure is provided at approximately 20-25 psi in order to have the piston rod 36 reach this intermediate position shown in FIGS. 4A and 4B. The height the piston rod 36 is lifted may be changed by reducing/increasing the pressure of air provided, thus requiring more/less than one pulse to allow a single drop of fluid to pass through the valve device and into the receiving container. If the pressure is increased sufficiently and the viscosity is low engough, a short stream is emitted instead of a single drop on each pulse. For even greater amounts, the pressure may be raised on each pulse such that the piston rod 36 fully exits the first bore section 92.

During this pulsing process, on each stroke, fluid is pushed into the grooves by the pressure of the pumps (and gravity) and then out of the grooves and the valve device. In the intermediate position, the seal on the piston rod expands into the grooves only enough to block approximately 20% of the area of the grooves. Thus, the pumps and gravity can still force some fluid through the grooves. The relationship between the pump force and surface tension caused in the grooves determines how much fluid can pass therethough, as well as of course, the viscosity of the fluid being distributed. The frequency of the pulsing of the piston rod (moving between closed and intermediate postions) also determines how much fluid may exit. Typical pulse rates can be 2 pulses per second, but any pulse rate is possible. Increased pressure lifts the piston rod higher in each pulse stroke, and may be so as that the seal of the piston rod is spaced from the seal contact surface.

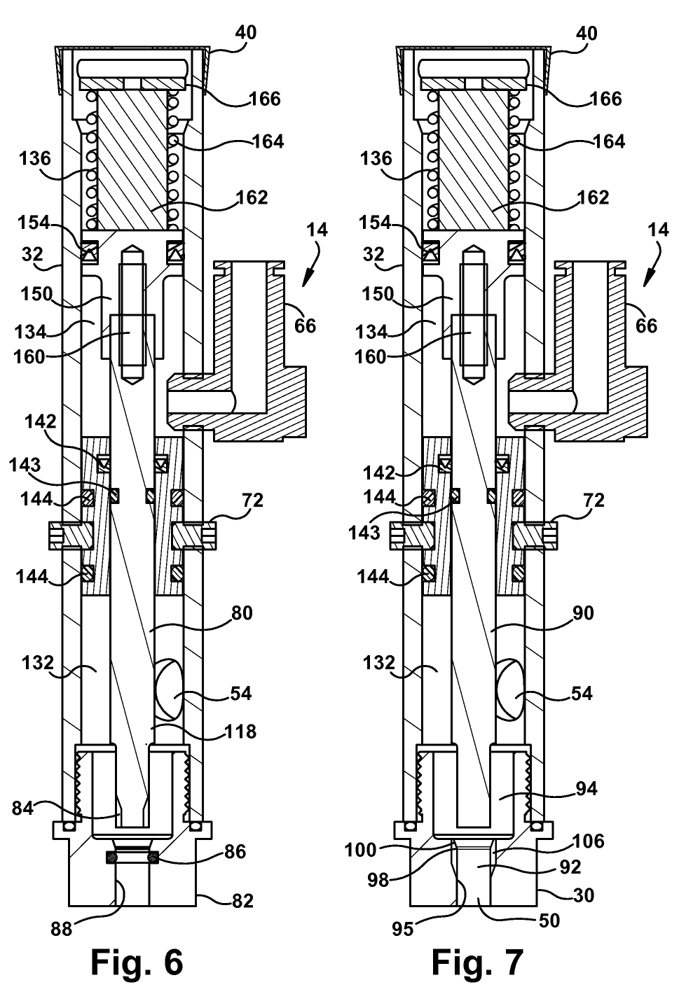

FIG. 6 shows an alternative version of a piston rod 80 and end cap 82. Here, similarly sized linear grooves 84 are placed in the piston rod 80 while a seal 86 is supported on the inner surface 88 of the end cap 82. In FIG. 7, no seal is placed on the piston rod 90. Close tolerance of the piston rod 90 and end cap 30 provides the required seal function.

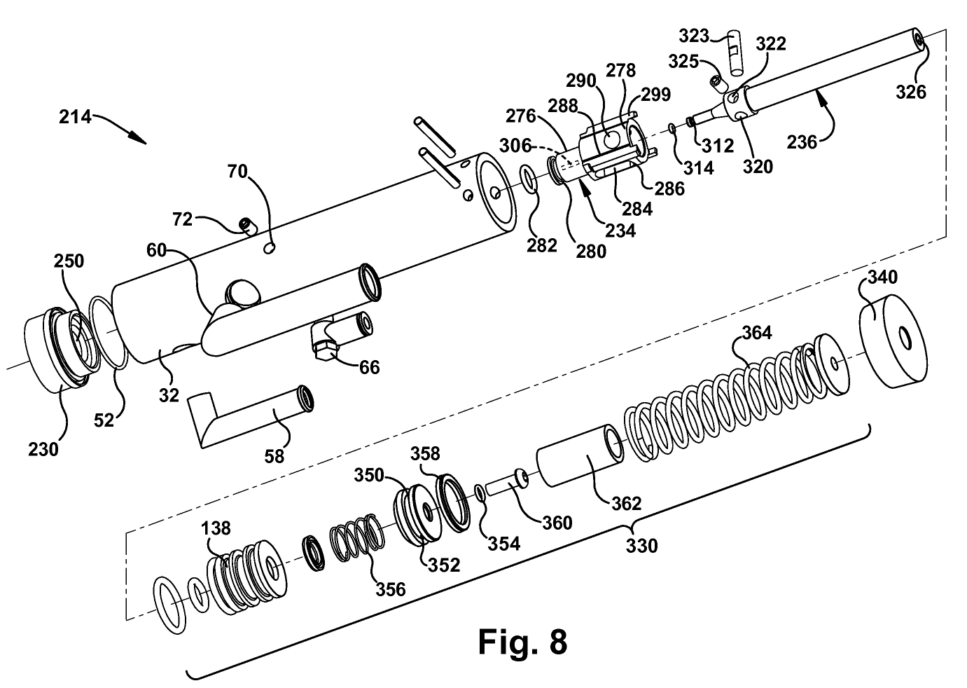

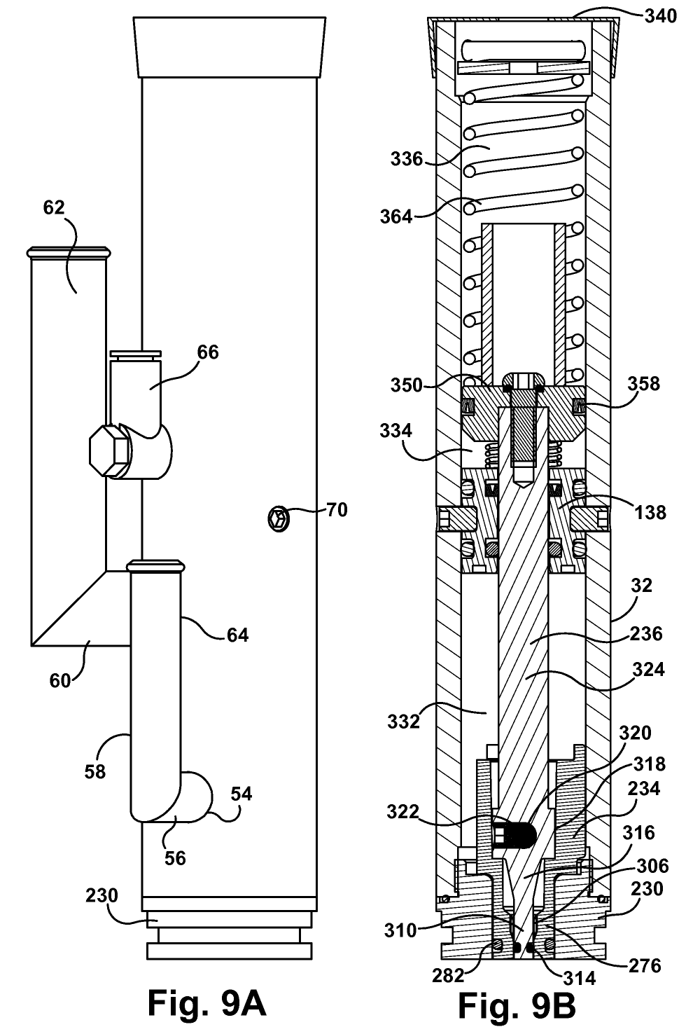

Referring to FIGS. 8, 9A-B and 11, in a second embodiment of the invention, an insert 234 fits within the main body 32, with a distal end portion of the insert 276 pressed into an alternate distal end cap 230. The insert 234 includes the narrow distal end portion 276 and a wider proximal end portion 278. The distal end portion 276 is cylindrical and includes an annular groove 280 on its exterior surface. The groove 280 holds the O-ring 282 that seals against an inner surface of the distal end cap bore 250 when the insert 234 is pressed therein. Progressing along the exterior surface of the insert 234 from the distal end portion 276 to the proximal end portion 278, the surface includes a step from the smaller diameter to the larger diameter proximal end portion 278. On opposite sides of the proximal portion 276, two axially extending apertures 284 with rounded ends 286 are provided. These apertures 284 extend laterally into an inner bore of the proximal end portion 278. Three rectangular grooves 288 extend axially along almost the entire length of the exterior surface of the proximal end portion 278 and are spaced, radially, equal from each other. These grooves align the insert 234 within the main body 32. A circular transverse aperture 290 passes through the sidewall of the proximal portion 278 near the proximal end as well and extends into a center bore. This aperture provides access for a wrench to tighten a set screw on the piston rod 236.

Returning to the distal end portion 276 of the seat device 234, a longitudinal bore 250 is provided therein, beginning at the distal end and extending toward the proximal end. The bore includes at least three distinct sections 292, 294 and 296 with different diameters. The first section 292 has the smallest diameter and is adjacent the distal end of the seat device 234. Two countersunk transition sections 298 and 300 are located between the first and second bore sections 292 and 294. The first transition section 298 has a sidewall 302 with a smaller angle with respect to a longitudinal axis of the seat device 234 than the second transition section's sidewall 304, the second transition section 300 being adjacent to the second bore section 294. The sidewall of the second transition 304 is at an angle of approximately 140 degrees with respect to the longitudinal axis of the seat device 234.

Two longitudinal grooves 306 extend from the first bore section 292 into the first transition section 298. These grooves 306 are generally rectangular and have a sloped distal end 308 that extends from the base of the groove 306 to the wall surface of the first bore section 292. The sloped distal end 308 is at an angle of 160 degrees to the longitudinal axis of the seat device 234. This helps prevent damage to the O-ring on the piston when it moves across the grooves. The proximal end of each groove 308 ends at about the transition between the first and second countersunk sections 298 and 300. The distal end of each groove 306 ends about midway along the length of the first bore section 292. The depth of each groove 306 is approximately 0.03 inches and has a width of approximately 0.04 inches. The grooves 306 are narrow enough to prevent the O-ring 314 from fully expanding into and blocking the groove 306. Thus, if the size of the O-ring 312 is modified, the size of the groove 306 can be changed accordingly, or vise-versa.

The depth and number of grooves 306 in the inner surface of the insert 234 determine how much fluid can enter and pass through the valve device 214 when the seal 314 on the piston rod 236 passes over the grooves 306. Edges of the grooves 306 that are on the surface of the insert 234 that contact the O-ring seal 314 are rounded so that the O-ring seal 314 is not damaged when it moves along the grooves 306.

The second section 294 of the longitudinal bore has a greater diameter than the first section 292. The second section 294 is located between the first section 292 and the third section 296. The third section 296 has a greater diameter than both the first and second sections of the longitudinal bore, and is constant. The third section 296 of the bore extends to the proximal end of the insert 234. Three or more wings 299 are spaced equally around the outer surface of the section 278 of the insert 234 and help guide the insert within the main body 32.

The surface of first section 292 of the longitudinal bore functions as the contact surface for the seal 314 on the piston rod 236. Referring to FIGS. 8 and 9B, the piston rod 236 is elongate and is more narrow at its distal end. The piston rod's distal end fits into the insert 234, as described in more detail below. A first piston portion 310 begins at the distal end and has a constant diameter. An annular groove 312 is within the outer surface of the first piston portion 310 adjacent the distal end. An O-ring 314 is seated in this annular groove 312. A second portion 316, which is adjacent to the first portion 312 is conical with a diameter which gets larger progressing away from the piston's distal end. A third portion 318 is adjacent to the second portion 316 and has a diameter greater than both the first and second portions 310 and 316. The third portion 318 includes a transverse circular bore 320 passing through the full diameter of the piston. A second transverse circular bore 322, offset 90 degrees from the first transverse bore 320 passes from the exterior surface of the piston into the first bore 320. The second bore 322 is threaded. A cross pin 323 is inserted through the first bore 320 and extends from each end of the bore 320. A set screw 325 holds the cross pin 323 in position. A fourth piston portion 324 is adjacent to the third piston portion 318 and extends from the third piston portion 318 to the proximal end of the piston. The fourth portion 324 has a diameter greater than the first and second portions 310 and 316, but smaller than the third portion 318. An axial bore 326 is placed in the proximal end of the piston and this bore is threaded.

Referring to FIGS. 8 and 9B, a spring and piston system 330 is used to create three separate chambers 332, 334 and 336 within the main body 232 and used to provide desired motion of the components held therein. A first cylindrical divider 138 is placed midway along the length of the main body's interior. This divider 138 is the same as the divider within the first embodiment of the invention. This divider 138 segregates the main body into a first lower chamber 332 for receiving the base fluid and an upper space, part of which receives compressed air.

A piston/seal 350 is located in the upper space of the main body 234 and is slidable axially therein. The piston/seal 350 includes an annular groove 352 into which a U-cup ring 358 of rubber or another slidable material fits. The ring 358 allows easy sliding movement of the piston/seal 350 in the main body 232. The piston/seal 350 divides the upper space into the second and third chambers 334 and 336.

A spring 356 is located between and abuts the divider 138 and piston/seal 350. Thus, this spring 356 biases the divider 138 and piston/seal 350 apart. The piston/seal 350 includes an axial bore. A screw 360 passes through this axial bore and secures an O-ring 354 and the piston/seal 350 to the proximal end of the piston rod 236. Thus, when the piston/seal 350 is biased away from the divider 138, the piston rod 236 is lifted, and moves out of a sealing position within the insert 234.

A cylindrical motion stop 362 is also unsecured. The cylindrical motion stop 362 is located within the third chamber 336 between the piston/seal 350 and the proximal end cap 340 and positions a third spring 364 therein. This spring 364 biases the piston/seal 350 toward the divider 138 and against the spring force of the second spring 356.

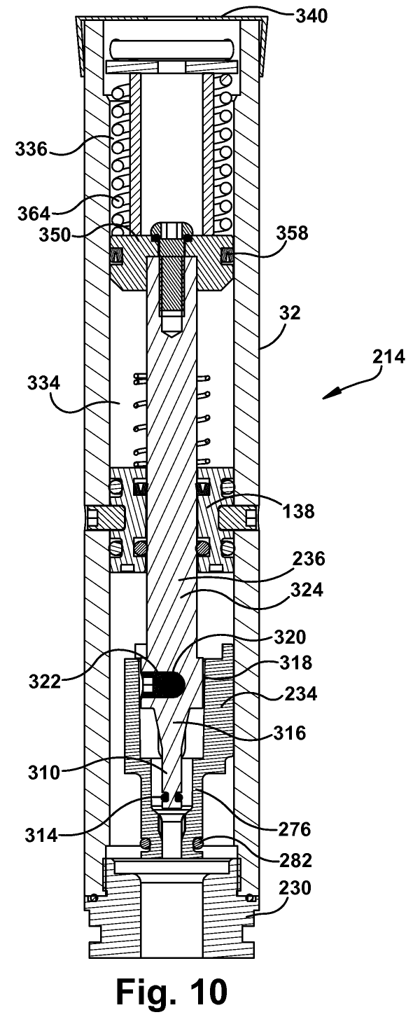

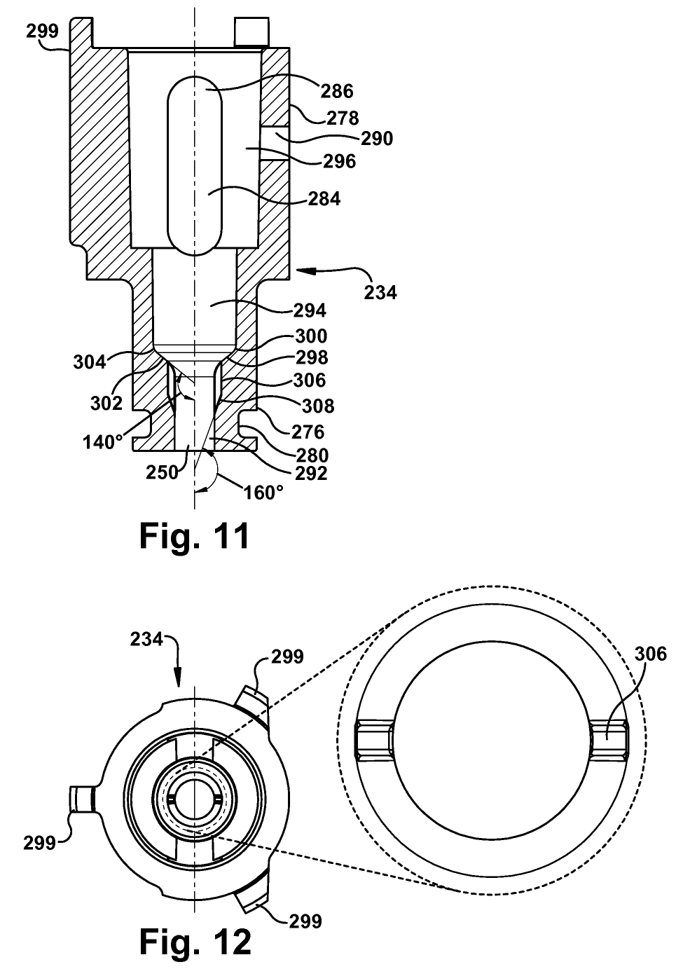

Again, air pressure is added through the air fitting 66 into chamber 334. This moves the piston/seal 350 and piston rod 316 upwards. FIG. 9B shows the valve device 214 in a closed position. FIG. 10 shows the valve 214 device in a full open position. The piston rod 236 raises the insert 234 up as well in this highest position, the pin 323 sliding within the aperture 284 until abuts the edge then raising the insert 234 (refer to FIG. 8). Thus, fluid can pass out of the valve device 214 in two ways. Fluid flows past the piston rod 236, around the seal and also around the exterior of the insert 234 and the seal 282 thereon, thus, a large amount of liquid can be discharged. The grooves 288 within the insert 234 aid in this fast flow.

The valve device has been described as using compressed air to move the piston rod, thus opening the valve. Any compressed fluid could be used alternatively. Also alternatively, a mechanical system, such as an electric motor linear actuator and associated gears/cams may be used to raise the piston rod instead of an air driven system. The return fluid port is optional, as all fluid within the valve may be dispensed instead of returning fluid to the supply container. Alternatively, any seal that does not fully fill the groove in the seal contact surface can be used instead of O-ring seals.

In one example of operation of the valve device, which is not limiting other operating speeds, a cycle of movement is from a first position where the seal is against a smooth portion of the seal contact surface to a second position where the seal is against grooves in the seal contact surface and back to first position, and at least 2 cycles are performed per second.

The valve device and method have been described for use in mixing fluid ink. Other fluids that may be mixed included different paints, or pharmaceutical ingredients.

This new valve device and method of operation allows fluid to be distributed in a very precise dropwise manner.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents.

What is claimed is:

1. A valve device comprising:
a valve body defining a chamber for receiving fluid to be dispensed from the valve device;
a seal contact surface located on the valve body, near a location where fluid discharges from the chamber;
a groove formed in the seal contact surface;
a reciprocatable piston rod supporting a seal that slidingly contacts the seal contact surface, said piston rod received at least partially within the chamber;
wherein said groove and seal have structural configurations that prevent the seal from fully blocking the groove when the piston rod is in a first position where the seal contacts the portion of the seal contact surface including the groove, and as a result fluid within the chamber may enter the groove when the piston rod is in said first position.

2. The device of claim 1, wherein said groove is a first groove, and further comprising a second groove.

3. The device of claim 1, wherein the piston rod is linearly reciprocatable and the groove is linear and has a length oriented parallel to a direction of piston rod movement.

4. The device of claim 3, wherein the groove has a generally rectangular shape.

5. The device of claim 1, wherein the valve body includes an insert that fits within the chamber and the seal contact surface is provided on the insert.

6. The device of claim 1, wherein the seal is an O-ring supported on the piston rod.

7. The device of claim 1, wherein the seal contact surface includes a smooth portion having no grooves, located downstream from the grooves.

8. The device of claim 7, wherein in a second position, the seal is compressed between the piston rod and the smooth portion of the seal contact surface, thus preventing fluid from exiting the chamber.

9. A valve device comprising:
a valve body defining a chamber for receiving fluid to be dispensed from the valve device;
a seal on the valve body, near a location where fluid discharges from the chamber;
a reciprocatable piston rod defining a seal contact surface that slidingly contacts the seal, said piston rod received at least partially within the chamber, said seal contact surface having a first portion and a second portion, said first portion having a groove formed therein;
wherein said groove and seal have structural configurations that prevent the seal from fully blocking the groove when the piston rod is in a first position in which the seal contacts the first portion of the seal contact surface, and as a result fluid within the chamber may enter the groove when the piston rod is in said first position.

10. The device of claim 9, wherein the piston rod is linearly reciprocatable and the groove is linear and has a length oriented parallel to a direction of piston rod movement.

11. The device of claim 10, wherein the second portion of the seal contact surface is a smooth portion having no grooves and the seal is compressable on the seal contact surface such that when said seal engages the second portion of the seal contact surface, fluid is prevented from exiting the chamber.

12. A method of dispensing fluid in variable amounts comprising the steps of:
providing a valve device comprising:
a valve body defining a chamber for receiving fluid to be dispensed from the valve device;
a seal contact surface located on the valve body, near a location where
fluid discharges from the chamber, said seal contact surface having a first portion and a second portion, said first portion having a groove formed therein and the second portion being smooth and located downstream from the first portion;
a reciprocatable piston rod supporting a seal that selectively contacts the seal contact surface, said piston rod received at least partially within the chamber;
wherein said groove and seal have structural configurations that prevent the seal from fully blocking the groove when the piston rod is in a first position where the seal contacts the first portion of the seal contact surface, and as a result fluid within the chamber may enter the groove when the piston rod is in said first position, and
wherein the piston rod is movable to a second position where the seal thereon contacts the second portion;
repeatedly moving the piston from the first position to the second position, thus moving the piston between a fully sealed position and a partially sealed position, and thus allowing fluid within the chamber to intermittently enter and pass through the groove and exit the valve device in a dropwise manner.

13. The method of claim 12, further including the step of moving the piston to a third position wherein the seal is spaced from the seal contact surface, allowing fluid within the chamber to exit the valve device in a stream.

14. The method of claim 12, wherein movement between the first position and second position is directly sequential, without in between movement to a third position where the seal is spaced from the seal contact surface.

15. The method of claim 12, wherein movement of the piston rod is effected through selectively adding compressed air into and releasing compressed air from a second chamber within the valve body.

16. A method of dispensing fluid in variable amounts comprising the steps of:
providing a valve device comprising:
a valve body defining a chamber for receiving fluid to be dispensed from the valve device;
a seal on the valve body, near a location where fluid discharges from the chamber;
a reciprocatable piston rod defining a seal contact surface that selectively contacts the seal, said piston rod received at least partially within the chamber, said seal contact surface having a first portion and a second portion, said seal contact surface first portion having a groove formed therein and the second portion being smooth;
wherein said groove and seal have structural configurations that prevent the seal from fully blocking the groove when the piston rod is in a first position in which the seal contacts the first portion of the seal contact surface, and as a result fluid within the chamber may enter the groove when the piston rod is in said first position;
repeatedly moving the piston from the first position to a second position in which the seal contacts the second portion of the seal contact surface, thus allowing fluid within the chamber to enter and pass through the groove and valve device in a dropwise manner.

17. The method of claim 16, further including the step of moving the piston to a third position wherein the seal is spaced from the seal contact surface, allowing fluid within the chamber to exit the valve device in a stream.

18. A method of dispensing fluid in variable amounts comprising the steps of:
providing a valve device comprising:
a valve body defining a chamber for receiving fluid to be dispensed from the valve device;
a seal contact surface located on the valve body, near a location where
fluid discharges from the chamber, said seal contact surface having a first portion and a second portion, said first portion having a groove formed therein and said second portion being smooth;
a reciprocatable piston rod supporting a seal that selectively contacts the seal contact surface, said piston rod received at least partially within the chamber;
wherein said groove and seal have structural configurations that prevent the seal from fully blocking the groove when the piston rod is in a first position where the seal contacts the first portion of the seal contact surface, and as a result fluid within the chamber may enter the groove when the piston rod is in said first position, and
wherein the piston rod is movable to a second position where the seal thereon contacts the second portion of the contact surface that has no grooves;
initially moving the piston to a third position where the seal is spaced from the seal contact surface, thus allowing fluid to be dispensed from the valve device in a stream;
subsequently, repeatedly moving the piston from the first position to the second position, thus allowing fluid within the chamber to enter the groove and pass through the groove and valve device in a dropwise manner.
